(19) United States
(12) Patent Application Publication
(10) Pub. No.: US 2005/0036650 A1
(43) Pub. Date: Feb. 17, 2005

(54) Control scheme for signal processing arrangement

(76) Inventors: John Bishop, Bath (GB); Antony James Smithson, North Yorkshire (GB); Steven Antony Meade, Bristol (GB); Mark Cope, Bath (GB)

Correspondence Address: MENDELSOHN AND ASSOCIATES PC, 1515 MARKET STREET, SUITE 715, PHILADELPHIA, PA, 19102, US

(21) Appl. No.: 10/480,779

(22) PCT Filed: Jun. 12, 2002
(86) PCT No.: PCT/GB02/02661

(30) Foreign Application Priority Data
Jun. 15, 2001 (GB) 0114798.2

(51) Int. Cl. G06K 9/00

(52) U.S. Cl. 382/100

(57) ABSTRACT

The control scheme uses the input and output signals of an amplifier (10) to control a lineariser (24) operating on the amplifier (10). The input and output signals are sensed and used to develop assay signals that have ideal inter-relationships when the amplifier is operating as desired. The control scheme modifies the operation of the lineariser to account for any departures observed in the relationships.

The invention relates to methods of, and apparatus for, controlling distortion counteracting equipment such as a predistorter.

In a case where signal handling equipment distorts a signal upon which it operates, it is known to use a lineariser to reduce distortion in the output signal of the equipment. It is known to perform linearisation adaptively by monitoring distortion or errors in the output signal and subsequently using information about these errors to adjust the linearisation.

An aim of the invention is to improve the manner in which distortion counteracting equipment, such as a predistorter, is controlled.

According to one aspect, the invention provides apparatus for controlling distortion counteracting equipment, said counteracting equipment operating to ameliorate distortion in an output signal produced by signal handling equipment in response to an input signal, the apparatus comprising sensing means for sensing the input and output signals and conditioning means for producing assay signals, namely an input envelope signal produced from the sensed input signal and a component correlation signal produced from the sensed input and output signals, said assay signals being for use in developing control signals for controlling the counteracting equipment.

The invention also consists in a method of controlling distortion counteracting equipment, said counteracting equipment operating to ameliorate distortion in an output signal produced by signal handling equipment in response to an input signal, the method comprising sensing the input and output signals and producing assay signals, namely an input envelope signal produced from the sensed input signal and a component correlation signal produced from the sensed input and output signals, said assay signals being for use in developing control signals for controlling the counteracting equipment.

Thus, the invention produces assay signals which can be used for controlling the counteracting equipment and which can be sampled arbitrarily without being constrained by the Nyquist criterion. This allows the assay signals to be sampled at any appropriate rate, permitting the use of low cost—low performance processors for manipulating the assay signals to control the counteracting equipment. This freedom from the sampling bandwidth constraints that would otherwise be imposed is particularly important where the input and output signals have a large bandwidth (e.g. where the input and output signals are wideband-CDMA signals). By using lower sampling rates, consumption of power and processing resources can be reduced in the signal processing hardware.

In a preferred embodiment, a second component correlation signal is derived from the sensed output signal and the three assay signals are used to develop control signals for the counteracting equipment.

The input envelope signal may be the square (or the modulus) of the sensed input signal's envelope and preferably, the input envelope signal is produced through summing the squares of orthogonal components of the sensed input signal. The component correlation signal may be produced through the difference of two products of component vectors of the sensed signals (i.e. the sensed input and output signals). For example, where the sensed signals are in IQ format, the products may be the product of the in-phase component of the sensed input signal and the quadrature phase component of the sensed output signal and the product of the quadrature phase component of the sensed input signal and the in-phase component of the sensed output signal. Alternatively, the component correlation signal may be produced through summing two products of component vectors of the sensed signals. For example, where the sensed signals are in IQ format, the products may be the product of the in-phase components of the sensed input and output signals and the product of the quadrature phase components of the sensed input and output signals. Where two component correlation signals are used, one component correlation signal may be formed by said summed products and the other component correlation signal may be formed by said differenced products. It should be noted that the products could be calculated using a different set of orthogonal vector axes for the components, i.e. a set of orthogonal axes other than the in- and quadrature-phase axes mentioned in the examples above.

In one embodiment, the relationship between the input envelope signal and a component correlation signal is assessed and departures of the relationship from its ideal form are used to produce control signals for making the counteracting equipment ameliorate the departure. In one embodiment, the departure constitutes a control signal for the counteracting equipment. For example, the ideal relationship between the component correlation signal and the input envelope signal can be a 1:1 correspondence, and departures from this relationship used to control a signal component (e.g. the departures are used to control the predistortion of a signal component of the input signal). Alternatively, the ideal relationship between the component correlation signal and the input envelope signal could, for example, be a 0:1 correspondence, and departures from this relationship used to control a signal component (e.g. the departures are used to control the predistortion of a component of the input signal).

Preferably, the sensed signals are time-aligned before the relationship is assessed for departures. Preferably, the sensed signals are phase-aligned to account for an intrinsic phase offset between the input and output signals before the relationship is assessed for departures from its ideal state. The time alignment can be achieved by adjusting a delay between the sensed signals. The phase alignment can be achieved by phase shifting one of the sensed signals relative to the other.

In a preferred embodiment, the signal handling equipment is an amplifier or amplifying arrangement, and the distortion counteracting equipment is for linearising the input-output characteristic of the amplification process. The lineariser may be, for example, a predistorter or a feed-forward arrangement.

The invention was described above in terms of methods for controlling distortion counteracting equipment, and the invention also extends to programmes for implementing such methods. Such programs may be stored in a suitable data store, e.g. a disk or a memory.

By way of example only, certain embodiments of the invention will now be described with reference to the accompanying drawings, in which:

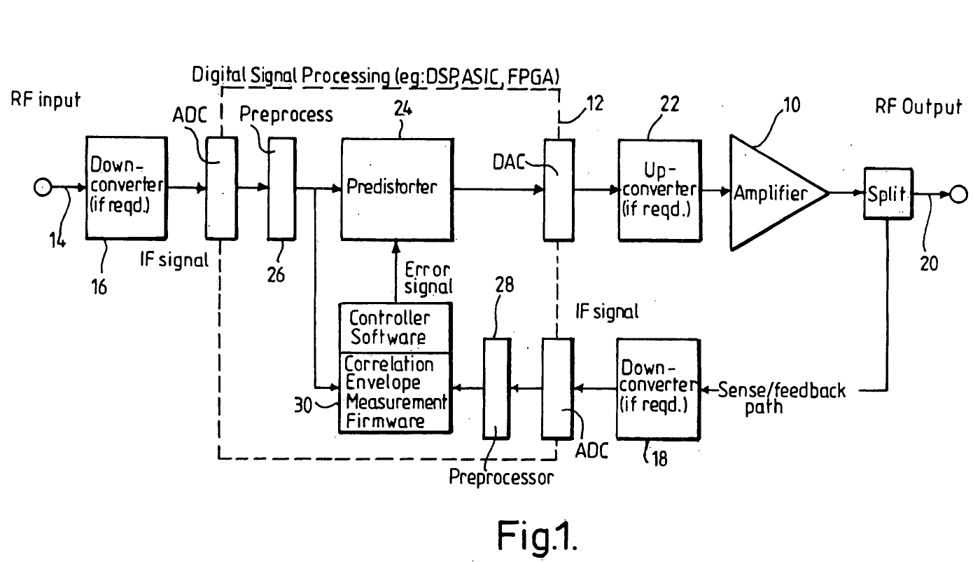

FIG. 1 is a block diagram of a lineariser operating on an amplifier;

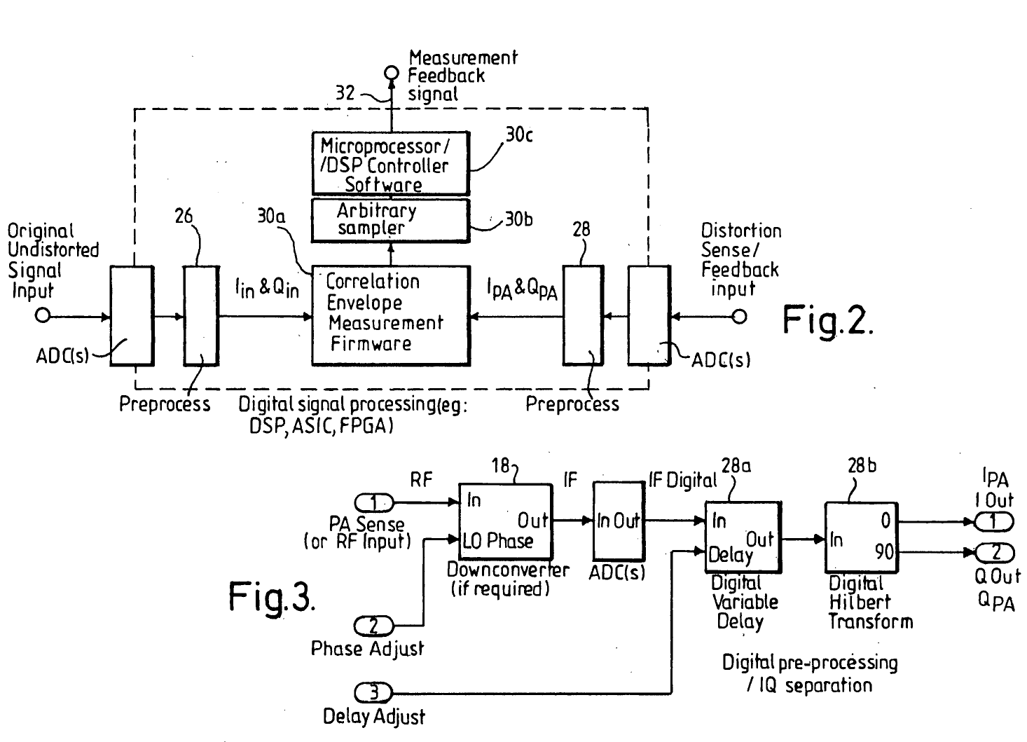

FIG. 2 is a block diagram of the control scheme for the lineariser of FIG. 1;

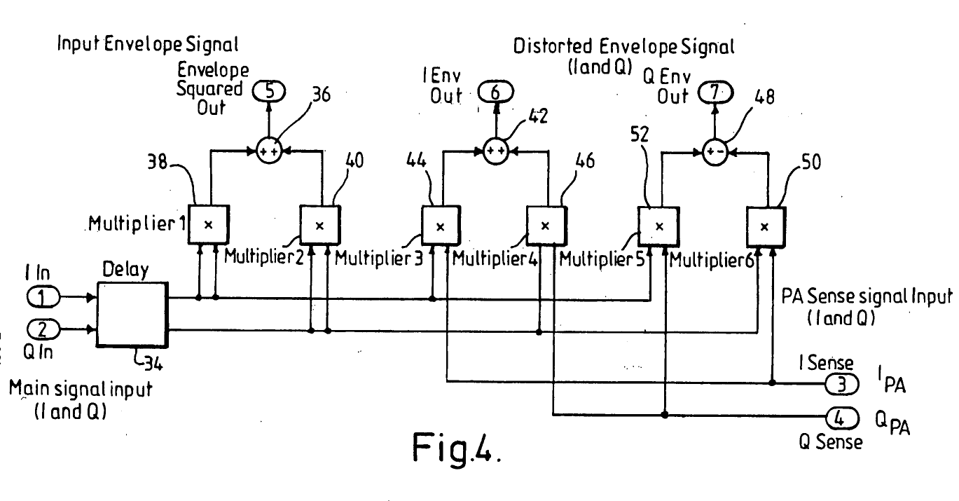

FIG. 3 is a block diagram of a preprocessing stage for the control scheme of FIG. 2;

FIG. 4 is a block diagram illustrating the signal processing within the control scheme of FIG. 2;

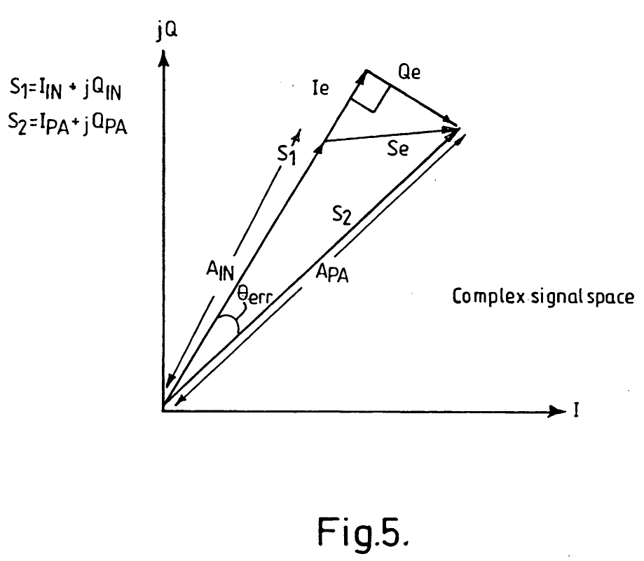

FIG. 5 is a complex signal space diagram illustrating the discrepancy between an amplifier input and an amplifier output;

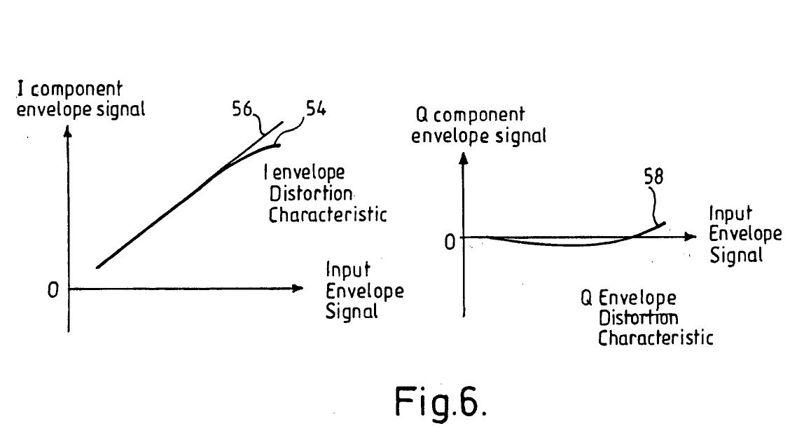

FIG. 6 shows two plots illustrating the transfer characteristics of an amplifier; and

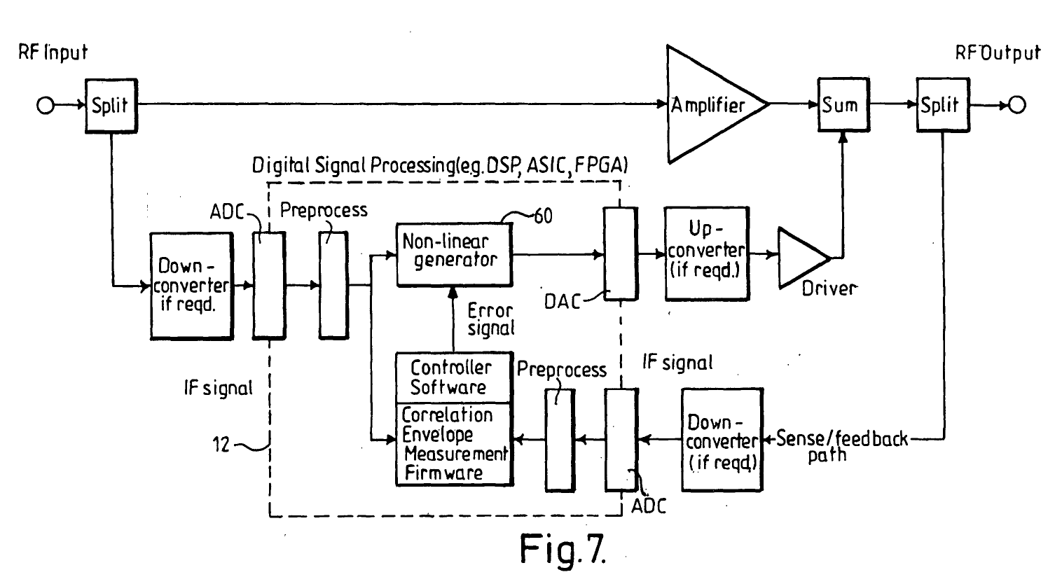

FIG. 7 illustrates another amplifier linearisation scheme.

The amplifier 10 of FIG. 1 is linearised by a digital signal processor (DSP) 12 operating on its input signal 14. Alternatively, the linearising function could be provided by an application specific integrated circuit (ASIC) or a field programmable gate array (FPGA) in place of the DSP 12. The DSP operates on the signal 14 in the digital domain at a given sample rate. Downconverter 16 is used if it is necessary to frequency downconvert the input signal 14 so that it is supported by the sampling rate of the DSP. Similarly, downconverter 18 performs the same task in respect of the sensed output 20 of the amplifier 10. The DSP 12 outputs a modified version of the input signal 14 and, if necessary, this is frequency up-converted by upconverter 22 before being supplied to amplifier 10. The DSP 12 implements a predistorter 24 which distorts the amplifier input signal in the digital domain in order to make the output signal 20 more linear. The DSP 12 also implements preprocessors 26 and 28 (which condition the signals supplied to the DSP 12) and a controller 30 which adapts the operation of predistorter 24 on the basis of the sensed input and output signals of the amplifier 10.

FIG. 2 illustrates the controller 30 in more detail and its relationship with the preprocessors 26 and 28. Each of the preprocessors 26 and 28 operates on its input signal to convert it into a quadrature format signal at an appropriate intermediate frequency (IF). Other tasks performed by the preprocessors 26 and 28 would be described later. The controller 30 comprises a correlator 30a which produces assay signals which indicate the presence of distortion in the amplifier output 20. The controller 30 also comprises an arbitrary sampler 30b which samples the assay signals of correlator 30a at arbitrary times or at an arbitrary rate. The controller 30 also comprises a control signal generator 30c which receives the samples of the assay signals from the sampler 30b and uses them to develop control signals 32 for adapting predistorter 24. The control signals from generator 30c cause the predistorter 24 to modify the way in which it predistorts the amplifier input signal in order to counteract residual distortion detected in the sensed amplifier output signal.

FIG. 3 shows the preprocessor 28 in more detail. The preprocessor 28 comprises a digital variable delay 28a for imparting an adjustable time delay to the sensed output signal. The sensed output signal is supplied from delay 28a to digital hilbert transform 28b which converts it into quadrature format. FIG. 3 also illustrates the optional downconverter 18. A phase adjust signal is supplied to the downconverter 18 to allow a variable phase adjustment to be made to the IF version of the sensed amplifier output signal. Similarly, a delay adjust signal is supplied to delay 28a to control the amount of delay imparted to the sensed amplifier output signal. The purpose of these adjustment signals will be described later. In an alternative embodiment, it may be possible to dispense with the downconverter and perhaps use one or multiple analogue to digital converters (ADCs) with direct sampling or direct undersampling to obtain suitable I and Q signals. This also includes schemes that use a 0 Hz IF (baseband processing).

The structure of preprocessor 26 differs in that it comprises only a digital hilbert transform for converting the digitised IF version of the sensed amplifier input signal to quadrature format.

FIG. 4 illustrates how the correlator 30a operates on the outputs of preprocessors 26 and 28 to produce three assay signals for sampling by arbitrary sampler 30b. A fixed digital delay 34 is applied to the quadrature format sensed input signal supplied by preprocessor 26. The correlator 30a produces an input envelope signal, which is the square of the envelope of the input signal, by summing 36 the square 38 of the in-phase component of the input signal and the square 40 of the quadrature phase component of the input signal. An I component correlation signal is produced by summing 42 the product 44 of the 0.1 components of the input and output signals and the product 46 of the Q components of the input and output signals. A Q component correlation signal is produced by subtracting 48 the product 50 of the Q component of the input signal and the I component of the output signal from the product 52 of the I component of the input signal and the Q component of the output signal.

The complex signal space diagram of FIG. 5 illustrates the input signals to the correlator 30a. Vector S₁ is the amplifier input signal and vector S₂ is the sensed amplifier output signal. Vector Sₑ is an error vector showing the discrepancy between the amplifier output and input signals, i.e. S₂−S₁. In FIG. 5, Sₑ has been decomposed into a component vector parallel to the amplifier input signal and a component vector Qₑ perpendicular to the amplifier input signal. The angle θₑᵣᵣ is a phase error between the input signal and the sensed output signal θₑᵣᵣ is the sum of an intrinsic phase offset θᵢₙₜ, which is intrinsic in the system between its input and its output, and a phase distortion angle θ_{dist}, which is phase distortion caused by the amplifier.

With reference to FIG. 5, the I component correlation signal is A_{IN.}A_{PA.} cos(θₑᵣᵣ) and the Q component correlation signal is A_{IN.}A_{PA}·sin(θₑᵣᵣ), where A_{IN} is the amplitude of S₁ and A_{PA} is the amplitude of S₂.

Before the assay signals (the input envelope signal and the I and Q component correlation signals) are used by the generator 30c to produce control signals for the predistorter, the amplifier input and output signals used in the multiplying processes 38, 40, 44, 46, 50 and 52 are brought into time alignment and are adjusted to remove the phase offset θᵢₙₜ. The time alignment is achieved by adjusting the variable delay 28a in preprocessor 28 and the phase offset θᵢₙₜ is eliminated by adjusting the phase of the sensed amplifier output signal in downconverter 18 using the phase adjust signal. The determination of the phase and delay adjustments will be described later. Note that in an alternative embodiment, the phase alignment may be implemented as a complex vector rotation of the I and Q component envelope signals.

The assay signals produced by the correlator 30a can be undersampled or arbitrarily sampled to build up a predominantly time-independent I/Q amplifier distortion characteristic at a rate that is convenient for the generator 30c, i.e. the assay signals are not subject to the Nyquist sampling criterion. The sampler 30b samples the assay signals simultaneously to produce a trio of samples. The sampler 30b produces trios of samples from the assay signals at a rate suited to the generator 30c. In an alternative embodiment the arbitrary sampler may operate on the inputs to the correlator so that a single multiplexed multiplier may be used in place of multipliers 38, 40, 44, 46, 50 and 52.

The generator 30c assesses the input envelope signal against each of the I component and Q component correlation signals and in each case determines whether the assessed signals depart from their ideal relationship (the departures indicating residual distortion in the amplifier output). In the ideal state (when the amplifier is linearised) the ratio of the input envelope signal to the I component correlation signal is 1:1 and the ratio of the input envelope signal to the Q component correlation signal is 1:0. FIG. 6a shows the I component correlation samples plotted against input envelope samples as curve 54. The ideal relationship for these two assay signals is indicated by straight line 56. FIG. 6b illustrates the Q component correlation samples plotted against the input envelope samples as curve 58. The ideal relationship between these two assay signals is merely a line along the input envelope signal axis.

The departure of each of the ratios from its ideal value constitutes a control signal that is used to correct the predistorter. The departure of the ratio of the I component correlation signal to the input envelope signal from its ideal 1:1 value represents residual AM to AM distortion in the amplifier output and in this embodiment forms a control signal for adjusting the predistortion of the in-phase component of the input signal. The departure of the ratio of the input envelope signal to the Q component correlation signal from its ideal 1:0 value indicates the presence of residual AM to PM distortion in the amplifier output and forms a control signal for adjusting the predistortion of the quadrature-phase component of the input signal in order to suppress the residual AM to PM distortion. It is not strictly necessary to eliminate the phase offset θᵢₙₜ, but if it is not eliminated then the ideal relationships for the assay signals will not be as stated above and the processing to produce control signals for the predistorter from the assay signals will be more complex.

As mentioned earlier, the sensed input and output signals are time aligned by adjusting the variable delay 28a. When these signals are time aligned, the amount of the variable delay 28a allows the measurement of the propagation delay through the amplifier. The fixed delay 34 is set to account for the fixed digital to analogue converter, analogue to digital converter and amplifier propagation delays of the system, plus an additional quantity of unit sample delays (the additional unit sample delays allow the relative delay between the sensed input and output signals to be adjusted both positively and negatively using only the variable delay 28a). Thus, if the values of the DAC and ADC delays and the fixed delay 34 are known, then the amplifier propagation delay can be calculated from the amount of the variable delay 28a.

It can be shown that the I/Q characteristics shown in FIG. 6 expand into lissajous-like loops if the sensed amplifier input and output signals are not time aligned. This has the effect of generating, as the signal amplitude varies naturally with time, a range of I component correlation signal and Q component correlation signal samples for any one given input signal envelope level. In general, the greater the time misalignment, the greater the variance of the I and Q component correlation signal samples for a given input signal envelope level. The variable delay 28a is adjusted until the variance in the I component and Q component correlation signal samples is minimised, which provides an indication that the sensed input and output signals are time aligned.

After the sensed input and output signals have been time aligned, the phase offset θᵢₙₜ between the sensed input and output signals is calculated and a phase correction is applied to the sensed output signal using the phase adjust input of downconverter 18 (this is achieved, for example, by adjusting the phase of a local oscillator signal within the downconverter). The phase offset θᵢₙₜ is calculated by the generator 30c as the four quadrant arctangent of the sum of recent I component correlation signal samples divided by the sum of corresponding I component correlation signal samples, with appropriate accounting for the quadrants defined by the signs of the sums. That is, the phase offset is calculated from:

$${θ}_{int} = Arc tan ( \frac{\sum Q comp correl sig samples}{\sum I comp correl sig samples} )$$

A simple pair of I component and Q component correlation signal samples can be used instead of sums of samples but the value obtained for θᵢₙₜ will be more prone to system noise. The samples used for the θᵢₙₜ calculation can be obtained arbitrarily from the assay signals and the sampling could be limited so that values that are obtained only from the region of the amplifier power curve that is known to be linear.

FIG. 7 illustrates how the DSP 12 can be used to perform linearisation techniques other than predistortion. Here, the DSP 12 operates on the sensed input signal using a non-linear generator 60 to produce a distorted version of the input signal which is combined with the output of the amplifier to counteract distortion there.

1-21. (canceled)

22. An apparatus for controlling distortion counteracting equipment, said counteracting equipment operating to ameliorate distortion in an output signal produced by signal handling equipment in response to an input signal, the apparatus comprising:
an input preprocessor adapted to generate a sensed input signal based on the input signal;
an output preprocessor adapted to generate a sensed output signal based on the output signal; and
a controller adapted to produce at least two assay signals, the at least two assay signals comprising (1) an input envelope signal produced from the sensed input signal and (2) a first component correlation signal produced from the sensed input and output signals, wherein the at least two assay signals are for use in developing control signals for controlling the counteracting equipment.

23. The invention of claim 22, wherein:
the signal handling equipment is an amplifier; and
the counteracting equipment is a predistorter or a feed-forward arrangement adapted to linearize the output signal produced by the amplifier.

24. The invention of claim 22, wherein the first component correlation signal is produced through a difference of two products of component vectors of the sensed input and output signals.

25. The invention of claim 24, wherein:
the component vector of the sensed input signal comprises in-phase component Iᵢₙ and quadrature-phase component Qᵢₙ;
the component vector of the sensed output signal comprises in-phase component Iₒᵤₜ and quadrature-phase component Qₒᵤₜ; and
the first component correlation signal is produced through a difference of (1) a product of Iᵢₙ and Qₒᵤₜ and (2) a product of Iₒᵤₜ and Qᵢₙ.

26. The invention of claim 22, wherein the first component correlation signal is produced through a sum of two products of component vectors of the sensed input and output signals.

27. The invention of claim 26, wherein:
the component vector of the sensed input signal comprises in-phase component Iᵢₙ and quadrature-phase component Qᵢₙ;
the component vector of the sensed output signal comprises in-phase component Iₒᵤₜ and quadrature-phase component Qₒᵤₜ; and
the first component correlation signal is produced through a sum of (1) a product of Iᵢₙ and Iₒᵤₜ and (2) a product of Qᵢₙ and Qₒᵤₜ.

28. The invention of claim 22, wherein the controller is further adapted to assess a relationship between the input envelope signal and the first component correlation signal and to use departures of the relationship from a specified ideal relationship to develop the control signals to cause the counteracting equipment to ameliorate the departures.

29. The invention of claim 28, wherein the apparatus is adapted to time-align the sensed input and output signals before the relationship is assessed for departures.

30. The invention of claim 29, wherein the apparatus comprises:
a fixed delay element adapted to apply a fixed delay to the sensed input signal; and
a variable delay element adapted to apply a programmable delay to at least one of the sensed input signal and the sensed output signal, wherein the variable delay is adapted to be adjusted to time-align the sensed input and output signals.

31. The invention of claim 30, wherein the variable delay is adapted to be adjusted to minimize variance in the first component correlation signal to time-align the sensed input and output signals.

32. The invention of claim 28, further comprising a phase-alignment element adapted to phase-align the sensed input and output signals before the relationship is assessed for departures.

33. The invention of claim 32, wherein the phase-alignment element is part of a downconverter adapted to downconvert the sensed output signal.

34. The invention of claim 22, wherein the controller is further adapted to produce a second component correlation signal from the sensed input and output signals, wherein the input envelope signal and the first and second component correlation signals are for use in developing the control signals for controlling the counteracting equipment.

35. The invention of claim 34, wherein:
the first component correlation signal is produced through a difference of two products of component vectors of the sensed input and output signals; and
the second component correlation signal is produced through a sum of two products of the component vectors of the sensed input and output signals.

36. The invention of claim 35, wherein:
the component vector of the sensed input signal comprises in-phase component Iᵢₙ and quadrature-phase component Qᵢₙ;
the component vector of the sensed output signal comprises in-phase component Iₒᵤₜ and quadrature-phase component Qₒᵤₜ;
the first component correlation signal is produced through a difference of (1) a product of Iᵢₙ and Qₒᵤₜ and (2) a product of Iₒᵤₜ and Qᵢₙ; and
the second component correlation signal is produced through a sum of (1) a product of Iᵢₙ and Iₒᵤₜ and (2) a product of Qᵢₙ and Qₒᵤₜ.

37. The invention of claim 36, wherein the controller is further adapted to:
assess a first relationship between the input envelope signal and the first component correlation signal and use departures of the first relationship from a specified first ideal relationship to develop a first control signal to cause the counteracting equipment to ameliorate the departures; and
assess a second relationship between the input envelope signal and the second component correlation signal and use departures of the second relationship from a specified second ideal relationship to develop a second control signal to cause the counteracting equipment to ameliorate the departures.

38. The invention of claim 37, wherein:
the first ideal relationship is a ratio of 1:0 between the input envelope signal and the first component correlation signal; and
the second ideal relationship is a ratio of 1:1 between the input envelope signal and the second component correlation signal.

39. The invention of claim 38, wherein:
the counteracting equipment is a predistorter adapted to predistort the input signal applied to the signal handling equipment;
the first control signal is used to adjust predistortion of a quadrature-phase component of the input signal; and
the second control signal is used to adjust predistortion of an in-phase component of the input signal.

40. A method for controlling distortion counteracting equipment, said counteracting equipment operating to ameliorate distortion in an output signal produced by signal handling equipment in response to an input signal, the method comprising:
generating a sensed input signal based on the input signal;
generating a sensed output signal based on the output signal; and
producing at least two assay signals, the at least two assay signals comprising (1) an input envelope signal produced from the sensed input signal and (2) a first component correlation signal produced from the sensed input and output signals, wherein the at least two assay signals are for use in developing control signals for controlling the counteracting equipment.

41. The invention of claim 40, further comprising producing a second component correlation signal from the sensed input and output signals, wherein the input envelope signal and the first and second component correlation signals are for use in developing the control signals for controlling the counteracting equipment.

42. The invention of claim 41, wherein:
the first component correlation signal is produced through a difference of two products of component vectors of the sensed input and output signals; and
the second component correlation signal is produced through a sum of two products of the component vectors of the sensed input and output signals.

43. The invention of claim 42, wherein:
the component vector of the sensed input signal comprises in-phase component Iᵢₙ and quadrature-phase component Qᵢₙ;
the component vector of the sensed output signal comprises in-phase component Iₒᵤₜ and quadrature-phase component Qₒᵤₜ;
the first component correlation signal is produced through a difference of (1) a product of Iᵢₙ and Qₒᵤₜ and (2) a product of Iₒᵤₜ and Qᵢₙ; and
the second component correlation signal is produced through a sum of (1) a product of Iᵢₙ and Iₒᵤₜ and (2) a product of Qᵢₙ and Qₒᵤₜ.

44. The invention of claim 43, further comprising:
assessing a first relationship between the input envelope signal and the first component correlation signal and using departures of the first relationship from a specified first ideal relationship to develop a first control signal to cause the counteracting equipment to ameliorate the departures; and
assessing a second relationship between the input envelope signal and the second component correlation signal and using departures of the second relationship from a specified second ideal relationship to develop a second control signal to cause the counteracting equipment to ameliorate the departures.

45. The invention of claim 44, wherein:
the first ideal relationship is a ratio of 1:0 between the input envelope signal and the first component correlation signal; and
the second ideal relationship is a ratio of 1:1 between the input envelope signal and the second component correlation signal.

46. The invention of claim 45, wherein:
the counteracting equipment is a predistorter adapted to predistort the input signal applied to the signal handling equipment;
the first control signal is used to adjust predistortion of a quadrature-phase component of the input signal; and
the second control signal is used to adjust predistortion of an in-phase component of the input signal.

47. An apparatus for controlling distortion counteracting equipment, said counteracting equipment operating to ameliorate distortion in an output signal produced by signal handling equipment in response to an input signal, the apparatus comprising:
means for generating a sensed input signal based on the input signal;
means for generating a sensed output signal based on the output signal; and
means for producing at least two assay signals, the at least two assay signals comprising (1) an input envelope signal produced from the sensed input signal and (2) a first component correlation signal produced from the sensed input and output signals, wherein the at least two assay signals are for use in developing control signals for controlling the counteracting equipment.
